(19) United States
(12) Patent Application Publication
(10) Pub. No.: US 2015/0367600 A1
(43) Pub. Date: Dec. 24, 2015

(54) TRANSPARENT DOUBLE-SIDED ADHESIVE SHEET, LAMINATE OBTAINED USING SAME FOR CONSTITUTING IMAGE DISPLAY DEVICE, PROCESS FOR PRODUCING SAID LAMINATE, AND IMAGE DISPLAY DEVICE OBTAINED USING SAID LAMINATE

(71) Applicant: MITSUBISHI PLASTICS, INC., Chiyoda-ku, Tokyo (JP)

(72) Inventors: Kahoru NIIMI, Nagahama-shi (JP); Makoto INENAGA, Nagahama-shi (JP); Ryota YAMAMOTO, Nagahama-shi (JP)

(73) Assignee: MITSUBISHI PLASTICS, INC., Chiyoda-ku, Tokyo (JP)

(21) Appl. No.: 14/764,780

(22) PCT Filed: Feb. 4, 2014
(86) PCT No.: PCT/JP14/52510

§ 371 Date: Jul. 30, 2015

(30) Foreign Application Priority Data
Feb. 12, 2013 (JP) 2013-024751
Feb. 12, 2013 (JP) 2013-024752

(51) Int. Cl. B32B 7/12; B32B 37/12; C09J 133/08; B32B 27/30

(52) U.S. Cl. CPC B32B 7/12; B32B 27/308; B32B 37/12; C09J 133/08; B32B 2307/412; B32B 2457/20; B32B 2305/72; C09J 2433/003

(57) ABSTRACT

One embodiment of the present invention provides a new transparent double-sided adhesive sheet that, in bonding of image display device-constituting members provided with a step portion on the bonding surface thereof with a transparent double-sided adhesive sheet interposed therebetween, can conform to the step portion to fill every corner therewith, can also allow strain generated in the adhesive sheet to be relaxed, and furthermore can maintain foaming resistance under a high-temperature and/or high-humidity environment without impairment of handleability. One embodiment of the present invention proposes a transparent double-sided adhesive sheet in a B-stage state, in which, first, the transparent double-sided adhesive sheet contains at least one (meth)acrylate (co)polymer, an ultraviolet polymerization initiator (A) having a molar absorptivity at a wavelength of 365 nm of 10 or more and a molar absorptivity at a wavelength of 405 nm of 0.1 or less, and a visible light polymerization initiator (B) having a molar absorptivity at a wavelength of 405 nm of 10 or more, and, second, a value (E′/G′) obtained by dividing a dynamic storage elastic modulus (E′) at 60° C. determined by a tension method, by a dynamic storage elastic modulus (G′) at 60° C. determined by a shear method is 10 or more.

### TECHNICAL FIELD

The present invention relates to a transparent double-sided adhesive sheet that can be suitably used for bonding constituent members of an image display device such as a personal computer, a personal digital assistant (PDA), a game machine, a television (TV), a car navigation system, a touch panel or a pen tablet, as well as a laminate obtained using the sheet for constituting an image display device, a process for producing the laminate and an image display device obtained using the laminate. In particular, the present invention relates to a transparent double-sided adhesive sheet that can be suitably used for bonding constituent members for an image display device, having a step portion on a bonding surface.

### BACKGROUND ART

In recent years, in order to enhance visibility of an image display device, a gap between an image display panel such as a liquid crystal display (LCD), a plasma display (PDP) or an electroluminescence display (ELD) and a protection panel or a touch panel member disposed on the front side (on the viewing side) thereof has been filled with an adhesive sheet, a liquid adhesive, or the like to suppress reflection of incident light or light emitting from a display image at the air/layer interface.

As the method for filling such a gap between constituent members for an image display device with a pressure-sensitive adhesive, a method is known which includes filling the gap with a liquid adhesive resin composition containing an ultraviolet curable resin, and then irradiating the composition with ultraviolet light for curing (Patent Literature 1).

In such a process, however, not only the operation in filling with the liquid adhesive resin composition is complicated and productivity is poor, but also it is difficult to cure the pressure-sensitive adhesive in a region which ultraviolet light hardly reaches, such as a region shielded by a print shielding layer, and therefore a problem is that it is difficult to achieve a stable quality.

Then, the gap between constituent members for an image display device has been filled with a pressure-sensitive adhesive sheet. For example, Patent Literature 2 discloses, as a transparent adhesive sheet that can be suitably used for bonding a transparent panel such as a protection panel or a touch panel to an image display panel, a transparent adhesive sheet that is an adhesive sheet which includes at least one first pressure-sensitive adhesive layer and at least one second pressure-sensitive adhesive layer having a different viscoelastic behavior from each other, and which has a configuration where these layers are laminated and integrated, in which the value of the dynamic shear storage elastic modulus G′ measured at a temperature dispersion with a frequency of 1 Hz is within a particular range.

Patent Literature 3 discloses a transparent double-sided pressure-sensitive adhesive sheet including an intermediate resin layer (A), and a pressure-sensitive adhesive layer (B) as each of front and rear layers, in which each of the layers is a layer having at least one (meth)acrylate type (co)polymer as a base resin, the storage shear elastic modulus (G′(A)) of the intermediate resin layer (A) at a frequency of 1 Hz in the temperature range from 0° C. to 100° C. is higher than that of the pressure-sensitive adhesive layer (B), and the indentation hardness (Asker C2 hardness) of the entire sheet is 10 to 80.

Patent Literature 4 discloses, as a thin (for example, 30 to 50 μm in thickness) pressure-sensitive adhesive sheet that can be applied to a surface having a step or protrusion, an ultraviolet crosslinkable pressure-sensitive adhesive sheet including a (meth)acrylic copolymer of a monomer containing (meth)acrylate having an ultraviolet crosslinkable moiety, in which the storage elastic modulus of the pressure-sensitive adhesive sheet before crosslinking by ultraviolet light is 5.0×10⁴ Pa or more and 1.0×10⁶ Pa or less at 30° C. and 1 Hz and is 5.0×10⁴ Pa or less at 80° C. and 1 Hz, and the storage elastic modulus of the pressure-sensitive adhesive sheet after crosslinking by ultraviolet light is 1.0×10³ Pa or more at 130° C. and 1 Hz.

Furthermore, Patent Literature 5 discloses, as a process for producing a laminate for constituting an image display device, the laminate having a configuration in which an image display device-constituting member is laminated on at least one side of a transparent double-sided adhesive sheet, a process including bonding a pressure-sensitive adhesive sheet subjected to primary crosslinking by ultraviolet light, to an image display device-constituting member, and thereafter irradiating the pressure-sensitive adhesive sheet with ultraviolet light, with the image display device-constituting member interposed, for secondary curing.

Patent Literature 6 discloses a process for providing a pressure-sensitive adhesive sheet, including coating a substrate with a composition, in which a syrup at 1000 to 125000 mPa·s obtained by partial polymerization of a radical polymerization monomer so that the polymer conversion is 30 to 60% is mixed with a radical polymerization initiator, and thereafter irradiating the composition with chemical rays for curing.

### CITATION LIST

### Patent Literature

Patent Literature 1: International Publication No. WO 2010/027041
Patent Literature 2: International Publication No. WO 2010/044229
Patent Literature 3: International Publication No. WO 2011/129200
Patent Literature 4: Japanese Patent Laid-Open No. 2011-184582
Patent Literature 5: Japanese Patent No. 4971529
Patent Literature 6: National Publication of International Patent Application No. 2007-510035

### SUMMARY OF INVENTION

### Technical Problem

In the field of an image display device, mainly, a mobile phone, a mobile terminal, and the like, not only thinning and an increase in precision, but also diversifying of design is advanced, and a new problem occurs in accordance therewith. For example, a shielding portion has been conventionally generally printed with black in a flame-like manner on the periphery portion of a surface protection panel, but such a flame-like shielding portion has been beginning to be formed with a color other than black in accordance with diversifying of design. When the shielding portion is formed with a color other than black, the color other than black is low in shieldability, and therefore the shielding portion, namely, a print portion tends to have a higher height than the shielding portion with black. Therefore, an adhesive sheet for bonding constituent members provided with such a print portion is demanded to have conformability to a print step, namely, to be capable of conforming to a large print step to fill every corner therewith.

In addition, an increase in the thickness of the print portion can cause a portion in contact with the print portion, of an image display device, to be stressed highly as compared with other portions thereof, resulting in strain to adversely affect optical properties, and therefore such strain is also demanded to be suppressed.

Therefore, a filling member such as an adhesive sheet is demanded to have higher stress relaxation properties (fluidity), but only an increase in fluidity causes storage stability and workability in handling of an adhesive sheet to be impaired, and furthermore, foaming resistance reliability of a laminated member bonded may be deteriorated.

In addition, a member that generates a gas (also referred to as “outgas”) under a high-temperature and/or high-humidity environment over time, such as a plastic protection panel, is included among constituent members of an image display device, and therefore, when a transparent double-sided adhesive sheet is used for bonding these constituent members of an image display device, the transparent double-sided adhesive sheet is also required to have a pressure-sensitive adhesion force and an aggregation force that can sufficiently counteract the pressure of the outgas.

Then, the present invention is intended to provide a new transparent double-sided adhesive sheet that, in bonding of image display device-constituting members provided with a step portion on the bonding surface thereof, with the transparent double-sided adhesive sheet interposed therebetween, can conform to the step portion on the bonding surface to fill every corner with the transparent double-sided adhesive sheet, can also allow strain generated in the adhesive sheet to be relaxed, and furthermore can maintain foaming resistance under a high-temperature and/or high-humidity environment without impairment of workability in handling, as well as a laminate obtained using the sheet for constituting an image display device, a process for producing the laminate and an image display device obtained using the laminate.

### Solution to Problem

The present invention proposes a transparent double-sided adhesive sheet in a B-stage state, in which, first, the transparent double-sided adhesive sheet contains at least one (meth)acrylate (co)polymer, an ultraviolet polymerization initiator (A) having a molar absorptivity at a wavelength of 365 nm of 10 or more and a molar absorptivity at a wavelength of 405 nm of 0.1 or less, and a visible light polymerization initiator (B) having a molar absorptivity at a wavelength of 405 nm of 10 or more; and, second, a value (E′/G′) obtained by dividing a dynamic storage elastic modulus (E′) at 60° C. determined by a tension method, by a dynamic storage elastic modulus (G′) at 60° C. determined by a shear method is 10 or more.

The present invention also proposes a process for producing a laminate for constituting an image display device, the laminate having a configuration in which an image display device-constituting member is laminated on at least one side of a transparent double-sided adhesive sheet, the process including at least the following steps (1) and (2):

(1) a step of molding an uncrosslinked adhesive composition to a monolayer or multilayer sheet, and irradiating the adhesive composition with visible light to crosslink the adhesive composition by visible light, thereby forming a transparent double-sided adhesive sheet in a B-stage state; and
(2) a step of laminating an image display device-constituting member on at least one side of the transparent double-sided adhesive sheet in a B-stage state, and irradiating the transparent double-sided adhesive sheet with light including ultraviolet light, with the image display device-constituting member interposed, for crosslinking by ultraviolet light.

### Advantageous Effects of Invention

The transparent double-sided adhesive sheet proposed by the present invention contains an ultraviolet polymerization initiator (A) and a visible light polymerization initiator (B), and therefore an uncrosslinked transparent double-sided adhesive sheet can be irradiated with visible light for crosslinking by visible light, thereby providing a transparent double-sided adhesive sheet in a B-stage state where ultraviolet crosslinkability remains. Alternatively, an uncrosslinked transparent double-sided adhesive sheet can be irradiated with ultraviolet light for crosslinking by ultraviolet light, thereby providing a transparent double-sided adhesive sheet in a B-stage state where visible-light crosslinkability remains.

In such a transparent double-sided adhesive sheet in a B-stage state, a value E′/G′ of the sheet of 10 or more means that the sheet is easily deformed in the case where extensional or compressive stress is applied in the perpendicular direction to a sheet surface, namely, applied with a sheet surface interposed, as compared with the case where extensional or compressive stress is applied in the parallel direction with a sheet surface, and the transparent double-sided adhesive sheet has a high dimension stability and a high deformation sensitivity to stress in the surface direction, namely, can conform to a step portion of a bonding surface.

Accordingly, when the transparent double-sided adhesive sheet proposed by the present invention is used to bond image display device-constituting members provided with a step portion on the bonding surface thereof, it can conform to the step portion on the bonding surface to fill every corner therewith, can also allow strain generated in the adhesive sheet to be relaxed, and furthermore can maintain foaming resistance under a high-temperature and/or high-humidity environment without impairment of workability in handling.

In the invention disclosed in Patent Literature 6, since a raw material having a low polymer conversion is used as a base resin, the monomer can easily remain as a low molecular weight substance or in the state of being unreacted after curing, to cause a low molecular component to contaminate a subject to be bonded, after bonding of members, or to deteriorate an aggregation force to the interface with a subject to be bonded, thereby causing foaming resistance reliability at high temperatures not to be sufficiently achieved. On the contrary, in the transparent double-sided adhesive sheet proposed by the present invention, an acrylate copolymer having a higher molecular weight is used as a base resin and therefore a low molecular weight component is less contained, and therefore such a problem can be solved.

The transparent double-sided adhesive sheet in a B-stage state obtained in step (1) leaves a margin for further crosslinking by ultraviolet light and is at least flexible by such a margin. Therefore, if unevenness due to a print step is present on the surface of a subject to be bonded, or unevenness due to the presence of foreign objects and the like is present on the interface for pressure-sensitive adhesion, the transparent double-sided adhesive sheet can flexibly conform to such unevenness to come into every corner. In addition, strain generated in the adhesive sheet can also be relaxed.

Therefore, such a transparent double-sided adhesive sheet in a B-stage state can be suitably attached closely to an image display device-constituting member in step (2).

In step (2), moreover, the transparent double-sided adhesive sheet in a B-stage state can be irradiated with light including ultraviolet light, with the image display device-constituting member interposed, for crosslinking by ultraviolet light to be tightly crosslinked and to be allowed to tightly adhere to the image display device-constituting member, and therefore the transparent double-sided adhesive sheet can have a pressure-sensitive adhesion force and an aggregation force that can sufficiently counteract the pressure of an outgas generated from, for example, a protection panel.

As described above, according to the process for producing a laminate for constituting an image display device, proposed by the present invention, conformability to unevenness and foaming resistance reliability that are generally in a trade-off relation can be simultaneously realized.

### DESCRIPTION OF EMBODIMENTS

Hereinafter, one example of embodiments of the present invention is described. The present invention, however, is not intended to be limited to one example of embodiments described below.

### <Present Adhesive Sheet 1>

A transparent double-sided adhesive sheet according to a first embodiment of the present invention (hereinafter, referred to as “present adhesive sheet 1”) is a transparent double-sided adhesive sheet in a B-stage state, having a monolayer configuration, in which the sheet is obtained by primarily curing an adhesive composition (hereinafter, referred to as “present adhesive composition 1”) containing at least one (meth)acrylate (co)polymer, an ultraviolet polymerization initiator (A) that initiates crosslinking by light in an ultraviolet region and a visible light polymerization initiator (B) that initiates crosslinking by light in a visible region, and further containing if necessary a crosslinking agent (C), if necessary a tackifier (D) and if necessary other component (E).

The present adhesive sheet 1 contains the ultraviolet polymerization initiator (A) and the visible light polymerization initiator (B), and therefore an uncrosslinked present adhesive composition 1 can be primarily cured by irradiation with visible light for crosslinking by visible light, to provide a transparent double-sided adhesive sheet in a B-stage state. Alternatively, an uncrosslinked present adhesive composition 1 can also be primarily cured by irradiation with light including ultraviolet light for crosslinking by ultraviolet light, to provide a transparent double-sided adhesive sheet in a B-stage state.

Above all, from the viewpoint of an increase in conformability of the present adhesive sheet 1 to unevenness, the uncrosslinked adhesive composition 1 is preferably irradiated with visible light for crosslinking by visible light, to provide a transparent double-sided adhesive sheet in a B-stage state where reactivity to ultraviolet light remains.

Accordingly, one preferable example of the process for producing the present adhesive sheet 1 can include a process including molding the present adhesive composition 1 containing the at least one (meth)acrylate (co)polymer, the ultraviolet polymerization initiator (A) that initiates crosslinking by light in an ultraviolet region and the visible light polymerization initiator (B) that initiates crosslinking by light in a visible region, and further containing if necessary the crosslinking agent (C), if necessary the tackifier (D) and if necessary other component (E), to a sheet on a release sheet, and primarily curing the composition by irradiation with visible light to provide the present adhesive sheet 1. The process, however, is not limited to such a production process.

In the above production process, in the case of irradiation with visible light, such irradiation is preferably conducted with visible light not substantially including light in an ultraviolet region, for example, light in a wavelength region of less than 380 nm in order to avoid the ultraviolet polymerization initiator (A) being reacted.

The phrase “not substantially including” here is intended to encompass a case where light in an ultraviolet region is more or less included because such a case may occur even if the light is purposely filtered, and, for example, light, if having a ratio of the light intensity in a wavelength region of less than 380 nm (for example, 350 nm in wavelength) to the light intensity in a wavelength region of 380 nm or more (for example, 410 nm in wavelength), of less than 10%, is considered not to substantially include light in an ultraviolet region.

### <Present Adhesive Sheet 2>

A transparent double-sided adhesive sheet according to a second embodiment of the present invention (hereinafter, referred to as “present adhesive sheet 2”) is a transparent double-sided adhesive sheet in a B-stage state, provided with

an intermediate layer S1 obtained by primarily curing an adhesive composition (hereinafter, referred to as “present adhesive composition 2”) containing at least one (meth)acrylate (co)polymer and a visible light polymerization initiator (B) that initiates crosslinking by light in a visible region, and further containing if necessary a crosslinking agent (C), if necessary a tackifier (D) and if necessary other component (E), and

an outermost layer S2 formed from an adhesive composition (hereinafter, referred to as “present adhesive composition 3”) containing at least one (meth)acrylate (co)polymer and an ultraviolet polymerization initiator (A) that initiates crosslinking by light in an ultraviolet region, and further containing if necessary a crosslinking agent (C), if necessary a tackifier (D) and if necessary other component (E).

Since the present adhesive sheet 2 may be provided with the intermediate layer S1 and the outermost layer S2, other layer may also be interposed between the intermediate layer S1 and the outermost layer S2, the outermost layer S2 may also be provided on each of both front and rear sides of the intermediate layer S1, or the outermost layer S2 may also be provided on one side of the intermediate layer S1 and other layer may be provided on the other side of the intermediate layer S1.

Above all, a configuration (S2/S1/S2) in which the outermost layer S2 is provided on each of both front and rear sides of the intermediate layer S1 is preferable.

In a step of preparing the present adhesive sheet 2, for example, irradiation with visible light allows the present adhesive composition 3 containing the visible light polymerization initiator (B) for crosslinking by visible light, thereby curing the intermediate layer S1. The outermost layer S2 here can be maintained in the state of being uncrosslinked, and therefore can be maintained in the state of being flexible and fluid. Accordingly, while the present adhesive sheet 2 maintains handling (handleability) by curing of the intermediate layer S1, the outermost layer S2 can fluidly conform to an uneven step even if such an uneven step is present on a bonding surface. The present adhesive sheet 2 can be thus said to be superior to the present adhesive sheet 1 from the viewpoint that the surface layer can be more flexible to enhance unevenness reliability.

In the present adhesive sheet 2 in a B-stage state, the present adhesive composition 3 of the outermost layer S2 may be uncrosslinked, namely, uncured, or may be partially crosslinked, namely, cured as long as reactivity to ultraviolet light remains.

### (Outermost Layer S2)

As the base resin in the present adhesive composition 3 that forms the outermost layer S2, the same base resin as that in the present adhesive sheet 1, namely, the (meth)acrylate (co)polymer can be used. The detail is described later.

Herein, the outermost layer S2 may contain the visible light polymerization initiator (B), but the content of the visible light polymerization initiator (B) is preferably low so that crosslinking of the outermost layer S2 does not progress in crosslinking of the intermediate layer S1 by visible light.

Specifically, the ratio (outermost Bm/intermediate Bm) of the number of parts by mass of the visible light polymerization initiator (B) (outermost Bm) based on 100 parts by mass of the (meth)acrylate (co)polymer in the outermost layer S2 to the number of parts by mass of the visible light polymerization initiator (B) (intermediate Bm) based on 100 parts by mass of the (meth)acrylate (co)polymer in the intermediate layer S1 is preferably less than 1, particularly preferably less than 0.5, above all, particularly preferably less than 0.05.

### (Intermediate Layer S1)

As the base resin in the present adhesive composition 2 that forms the intermediate layer S1, the base resin in the present adhesive sheet 1, namely, the (meth)acrylate (co)polymer can be used. The detail is described later.

Herein, the base resin in the present adhesive composition 2 that forms the intermediate layer S1 may be the same resin as or different from the base resin in the present adhesive composition 3 that forms the outermost layer S2. From the viewpoints of ensuring of transparency, ease of preparation, and also prevention of refraction at the interface between the intermediate layer S1 and the outermost layer S2, the base resins are preferably the same as each other.

Also with respect to each of the visible light polymerization initiator (B), the crosslinking agent (C), the tackifier (D) and other component (E) in the present adhesive composition 2, the same as in the present adhesive sheet 1 can be used. The detail is described later.

The intermediate layer S1 in a B-stage state can be formed so as not to be crosslinked by other electromagnetic wave, may be formed so as to be further crosslinked by other electromagnetic wave, or may be formed so as to be further crosslinked by heat.

For example, the intermediate layer S1 may also include the ultraviolet polymerization initiator (A) other than the visible light polymerization initiator (B). When the intermediate layer S1 includes the ultraviolet polymerization initiator (A), the intermediate layer S1 can be further crosslinked by irradiation with ultraviolet light.

An increased content of the crosslinking initiator, however, results in a reduction in light transmittance, and therefore the content of the crosslinking initiator in the intermediate layer S1 is preferably lower than the content thereof in the outermost layer S2.

### (Dynamic Storage Elastic Modulus (G′) of Each Layer by Shear Method)

In the present adhesive sheet 2, from the viewpoint that conformability in bonding to an unevenness portion such as a step due to a print portion having a height of 50 μm or more (referred to as “large print step”), and smoothness and processability after the bonding are balanced, the dynamic storage elastic modulus (G′) at 60° C. by a shear method of the intermediate layer S1 is preferably lower than the dynamic storage elastic modulus (G′) at 60° C. by a shear method of the outermost layer S2.

Above all, the ratio of the dynamic storage elastic modulus (G′) at 60° C. by a shear method of the intermediate layer S1 to the dynamic storage elastic modulus (G′) at 60° C. by a shear method of the outermost layer S2 is preferably 1.5 to 1000, above all, further preferably 2 or more and 500 or less.

The dynamic storage elastic modulus (G′) at 60° C. by a shear method of the intermediate layer S1 is preferably 1.0×10³ Pa to 1.0×10⁷ Pa. In the case where the dynamic storage elastic modulus (G′) is 1.0×10³ Pa or more, the intermediate layer S1 is excellent in dimension stability as the adhesive sheet, and in the case where the dynamic storage elastic modulus (G′) is 1.0×10⁷ Pa or less, strain is hardly caused in the adhesive sheet after bonding to an unevenness surface and such a case is preferable.

From such viewpoints, the dynamic storage elastic modulus (G′) at 60° C. by a shear method of the intermediate layer S1 is, above all, preferably 5.0×10³ Pa or more or 5.0×10⁶ Pa or less, above all, particularly preferably 1.0×10⁴ Pa or more or 1.0×10⁶ Pa or less.

With respect to both the intermediate layer S1 and the outermost layer S2, the dynamic storage elastic modulus (G′) by a shear method of each of the layers may be adjusted by, for example, adjusting the type and the compositional ratio of a comonomer for forming an acrylic (co)polymer as a base polymer, or adjusting irradiation conditions with light to adjust the degree of crosslinking.

### (Layer Thickness)

In the present adhesive sheet 2, the ratio ((S1)/(S2)) of the total layer thickness of the intermediate layer S1 to the total layer thickness of the outermost layer S2 is preferably 0.1<(S1)/(S2)<10.

In the case where the ratio of the thickness of the intermediate layer S1 to the thickness of the outermost layer S2 is within the above range, the contribution of the thickness of the present adhesive sheet 2 is not so large in a laminate for constituting an image display device, and an image display device, which are described later, and therefore workability in cutting and handling is not deteriorated by excessive flexibility and such a case is preferable. In addition, an adhesion force and wettability to a subject to be bonded can be maintained without deterioration in conformability to unevenness and a curved surface, and such a case is preferable.

From the viewpoints of conformability to a print step and a reduction in optical distortion after bonding in the vicinity of unevenness, the ratio is more preferably 0.1<(S1)/(S2)<1.

### (Production Process)

The present adhesive sheet 2 can be produced by the following process.

For example, each of the present adhesive composition 2 and the present adhesive composition 3 can be co-extruded between two transparent release sheets to prepare a bilayer laminated sheet, and the laminated sheet can be irradiated with visible light to thereby primarily cure the intermediate layer S1, providing the present adhesive sheet 2 in a B-stage state.

In the case of a trilayer configuration of the outermost layer S2, the intermediate layer S1 and the outermost layer S2, for example, each of the present adhesive composition 2 and the present adhesive composition 3 can be co-extruded between two transparent release sheets to prepare a trilayer laminated sheet, and the laminated sheet can be irradiated with visible light to thereby primarily cure the intermediate layer S1, providing the present adhesive sheet 2 in a B-stage state.

In the production process, when the laminated sheet is irradiated with visible light, the irradiation is preferably conducted with visible light not substantially including light of a wavelength in an ultraviolet region, for example, visible light not substantially including light in a wavelength region of less than 380 nm in order to avoid the present adhesive composition 3 containing the ultraviolet polymerization initiator (A) being crosslinked by ultraviolet light.

In the method of irradiation with visible light not substantially including light of a wavelength in an ultraviolet region, the irradiation may be conducted using a light source that emits only visible light not including light of a wavelength in an ultraviolet region, or may be conducted using a light source via a filter not transmitting light of a wavelength in an ultraviolet region. Alternatively, a wavelength in an ultraviolet region may be allowed not to reach each of the present adhesive sheets 1 and 2 by laminating a film not transmitting light of a wavelength in an ultraviolet region on one side or both sides of each of the present adhesive sheets 1 and 2 for irradiation with light, with the film interposed.

The phrase “not substantially including” here is intended to encompass a case where light in an ultraviolet region is more or less included because such a case may occur even if the light is purposely filtered, and, for example, light, if having a ratio of the light intensity in a wavelength region of less than 380 nm (for example, 350 nm in wavelength) to the light intensity in a wavelength region of 380 nm or more (for example, 410 nm in wavelength), of less than 10%, is considered not to substantially include light in an ultraviolet region.

The production process of the present adhesive sheet 2 is not limited to the above production process. For example, a sheet S1 for forming the intermediate layer S1 may be irradiated with visible light for crosslinking to form the intermediate layer S1, and thereafter the outermost layer S2 made of the present adhesive composition 3 may be laminated on one side or both sides of the intermediate layer S1, to prepare the present adhesive sheet 2.

### <Features of Present Adhesive Sheets 1 and 2>

The present adhesive sheets 1 and 2 are in common with each other in that both are each transparent double-sided adhesive sheet in a B-stage state, containing the at least one (meth)acrylate (co)polymer as the base resin, containing the ultraviolet polymerization initiator (A) that initiates crosslinking by light in an ultraviolet region and the visible light polymerization initiator (B) that initiates crosslinking by light in a visible region, and further containing if necessary a multifunctional (meth)acrylate resin (C) as the crosslinking agent and if necessary the tackifier (D).

The “B-stage state” here means an intermediate state of curing of an adhesive sheet having adhesiveness or pressure-sensitive adhesiveness, namely, a state where the adhesive sheet is not finally cured, and means a state where the adhesive sheet can be irradiated with light and further cured (crosslinked) to have higher adhesiveness. Here, a hot-melt type is also included in which the adhesive sheet is heated to be more flexible, and thereafter irradiated with light and cured (crosslinked). In addition, a pressure-sensitive type is also included in which the adhesive sheet is irradiated with light without heating, and cured (crosslinked). It is preferable to perform irradiation with ultraviolet light as irradiation with light and curing (crosslinking).

In a conventional adhesive sheet in which a transparent double-sided adhesive sheet has been primarily cured with crosslinking by ultraviolet light and thereafter secondarily cured with crosslinking by ultraviolet light, the reaction residue in primary curing has allowed secondary curing to be initiated, and therefore the amounts of changes in physical properties before and after secondary curing have been limited. It has been difficult to impart large changes before and after secondary curing, for example, a change in flexibility or fluidity in a B-stage state, and a change in adhesiveness or foaming resistance after secondary curing. On the contrary, in the present adhesive sheets 1 and 2, the type of the crosslinking initiator contributing to primary curing is different from the type of the crosslinking initiator contributing to secondary curing, and therefore the amounts of changes in physical properties before and after secondary curing can be larger than the above conventional case. Accordingly, a higher fluidity can be achieved and reliability of bonding to an unevenness surface can be increased in a B-stage state after primary curing (before secondary curing). On the other hand, tight curing by irradiation with ultraviolet light can be made after secondary curing, and therefore foaming resistance after bonding can be increased.

In addition, in a conventional process in which an adhesive material having both of photo-curing properties and thermosetting properties has been used for primary curing and then secondary curing, not only a thermosetting agent such as an organic peroxide, an isocyanate compound, an epoxy compound or an amine compound has caused gelation in processing of a composition, but also an aging period of several days has been taken for completion of the reaction, and therefore there has been the problem of poor productivity. On the contrary, with respect to the present adhesive sheets 1 and 2, both of primary curing and secondary curing are conducted by photo-crosslinking, and there is the following advantage: the problem in a thermosetting step can be eliminated.

In addition, when the above conventional process is compared with a process in which members to be bonded are bonded using an adhesive sheet not subjected to a primary crosslinking treatment or a hot-melt adhesive resin sheet and thereafter the resultant is subjected to a crosslinking treatment with heat or irradiation with ultraviolet light, the resulting sheet has been problematic in terms of poor processability and storage stability because the shape of the sheet has not been kept by crosslinking at the stage of not being subjected to the crosslinking treatment. On the contrary, with respect to the present adhesive sheets 1 and 2, visible light can be selectively used to perform primary crosslinking, thereby providing a B-stage state where the shape is kept, and therefore there is the following advantage: excellent processability and storage stability can be achieved as compared with the above conventional case.

### (E′/G′)

Both of the present adhesive sheets 1 and 2 can have a value (E′/G′) obtained by dividing the dynamic storage elastic modulus (E′) at 60° C. determined by a tension method, by the dynamic storage elastic modulus (G′) at 60° C. determined by a shear method, of 10 or more.

The dynamic storage elastic modulus (E′) determined by a tension method is the value of a physical property that represents the difficulty of deformation to stress applied in the parallel direction with the sheet surface. That is, it can be said that as the dynamic storage elastic modulus (E′) is higher, the sheet is better in dimension stability and storage stability.

On the other hand, the dynamic storage elastic modulus (G′) determined by a shear method in the shear direction represents the difficulty of deformation to stress applied in the perpendicular direction to the sheet surface, namely, stress applied with the sheet surface interposed. It can be said that as the dynamic storage elastic modulus (G′) is lower, the sheet is better in conformability in bonding to a surface to be bonded having an unevenness portion.

From the foregoing, it is considered that both of a high dynamic storage elastic modulus (E′) in the tension direction and a low dynamic storage elastic modulus (G′) in the shear direction can be satisfied to thereby simultaneously overcome the conflicting technical problems: excellent storage stability and excellent conformability to unevenness.

A value E′/G′ of each of the present adhesive sheets 1 and 2 of 10 or more means that extensional or compressive stress applied in the perpendicular direction to the sheet surface, namely, applied with the sheet surface interposed easily results in deformation as compared with extensional or compressive stress applied in the parallel direction with the sheet surface. In general, the relationship between the dynamic storage elastic modulus (E′) in the tension direction and the dynamic storage elastic modulus (G′) in the shear direction satisfies E′/G′=3 under the assumption of the material to an ideal elastic body (no change in volume during deformation). A common resin member also usually has a value E′/G′ of about 3. Accordingly, when the value E′/G′ at 60° C. of each of the present adhesive sheets 1 and 2 is 10 or more, each of the present adhesive sheets 1 and 2 is higher in dimension stability and higher in deformation sensitivity to stress in the surface direction, namely, superior in conformability to unevenness in bonding to a conventional adhesion or adhesive sheet.

From such viewpoints, the value E′/G′ of each of the present adhesive sheets 1 and 2 is preferably 10 or more, particularly preferably 15 or more, above all, particularly preferably 20 or more.

In the case where the value E′/G′ at 60° C. is 10 or more, the following failures due to deformation hardly occur: for example, when the present adhesive sheet is stored for a long period or exposed under a high-temperature environment, the present adhesive sheet is stretched, or is protruded from the end of a subject to be bonded after bonded to the subject to be bonded. Furthermore, the following failure hardly occurs: for example, when the present adhesive sheet is bonded to an unevenness portion, a gap remains near a step portion; and such a case is preferable.

On the other hand, the upper limit of the value E′/G′ is not particularly limited. In the case where the value E′/G′ is 100 or less, however, the following concerns are easily dissolved: for example, the dynamic storage elastic modulus (E′) in the tension direction is so high to deteriorate flexibility of the adhesive sheet, and the dynamic storage elastic modulus (G′) in the shear direction is so low to cause collapse of the adhesive sheet and attachment of trace; and such a case is preferable. In addition, such a case is preferable from the viewpoint of achieving storage stability and foaming resistance reliability in storing of the laminate, after bonding, under a high-temperature and/or high-humidity environment, and therefore the value E′/G′ is preferably 100 or less, particularly preferably 70 or less, above all, still more preferably 50 or less.

Examples of the method for adjusting the value E′/G′ of each of the present adhesive sheets 1 and 2 to 10 or more include (I) a method of adjustment by filling an adhesive layer composition with a filler having a different rigidity at 60° C., (II) a method of adjustment by laminating a resin layer having a different rigidity at 60° C., and (III) a method of adjustment by allowing the degree of crosslinking in the sheet (in the perpendicular direction) to be different, and allowing the sensitivities to stress in the tension direction and the shear direction to be different from each other. The adjustment method, however, is not limited to these methods.

In the method (I), a large amount of a filler is required to be compounded in order to express the anisotropy of the elastic modulus, and poor appearance and the like due to poor dispersion and the like can be caused. In addition, in the method (II), there are the following problems: layers having a different rigidity are laminated to thereby cause optical properties to be impaired, and the method is poor in terms of cost and productivity. On the contrary, the method (III), namely, the method in which the degree of crosslinking in the thickness direction of the sheet is allowed to be different, does not have such problems and therefore the method (III) is preferably adopted in the production process of the present adhesive sheet 1.

### (Dynamic Storage Elastic Modulus (E′) at 60° C. Determined by Tension Method)

The dynamic storage elastic modulus (E′) at 60° C. determined by a tension method, of each of the present adhesive sheets 1 and 2, is preferably 1.0×10⁴ Pa to 1.0×10⁵ Pa, above all, more preferably 5.0×10⁴ Pa or more or 5.0×10⁵ Pa or less. The dynamic storage elastic modulus (E′), however, is not limited to these ranges.

In the case where the dynamic storage elastic modulus (E′) by a tension method is 1.0×10⁴ Pa or more, such a case is preferable in terms of cutting processability of each of the adhesive sheets. Moreover, in the case where the dynamic storage elastic modulus (E′) by a tension method is 1.0×10⁵ Pa or less, such a case is preferable from the viewpoint that strain generated in each of the adhesive sheets after bonding to an unevenness surface can be relaxed.

The dynamic storage elastic modulus (E′) at 60° C. determined by a tension method, of each of the present adhesive sheets 1 and 2, can be determined by, for example, measuring the dynamic storage elastic modulus E′ at 60° C. by a tension method using a dynamic viscoelasticity measurement apparatus in a tensile mode of a vibrational frequency of 1 Hz at a measurement temperature of 0° C. to 100° C. and at a rate of temperature rise of 3° C./min.

With respect to the present adhesive sheets 1 and 2, examples of the method for adjusting the dynamic storage elastic modulus (E′) at 60° C. determined by a tension method can include a method for adjusting the type and the compositional ratio of a comonomer for forming the (meth)acrylate copolymer as the base polymer, a method for adjusting the amount of a crosslinking monomer to be added, and a method for adjusting the amount of irradiation of light and the like to thereby adjust the degree of crosslinking. The adjustment method, however, is not limited to these methods.

### (Dynamic Storage Elastic Modulus (G′) at 60° C. Determined by Shear Method)

The dynamic storage elastic modulus (G′) at 60° C. determined by a shear method, of each of the present adhesive sheets 1 and 2, is preferably 5.0×10² Pa to 1.0×10⁵ Pa, above all, particularly preferably 5.0×10³ Pa or more or 5.0×10⁴ Pa or less. The dynamic storage elastic modulus (G′), however, is not limited to these ranges.

In the case where the dynamic storage elastic modulus (G′) by a shear method is 5.0×10² Pa or more, the case is preferable in terms of storage stability of each of the adhesive sheets. In the case where the dynamic storage elastic modulus (G′) by a shear method is 1.0×10⁵ Pa or less, the case is preferable in terms of conformability to a surface to be bonded having unevenness.

The dynamic storage elastic modulus (G′) at 60° C. determined by a shear method, of each of the present adhesive sheets 1 and 2, can be determined by, for example, preparing a measurement specimen with each of the adhesive sheets laminated so that the thickness is 1 mm to 2 mm, and measuring the dynamic storage elastic modulus (G′) at 60° C. by a shear method, using a rheometer at a strain of 0.5%, a frequency of 1 Hz, a temperature of −50 to 200° C. and a rate of temperature rise of 3° C./min.

With respect to the present adhesive sheets 1 and 2, examples of the method for adjusting the dynamic storage elastic modulus (G′) at 60° C. determined by a shear method can include a method for adjusting the type and the compositional ratio of a comonomer for forming the (meth)acrylate copolymer as the base polymer, a method for adjusting the amount of a crosslinking monomer to be added, and a method for adjusting the amount of irradiation of light and the like to thereby adjust the degree of crosslinking. The adjustment method, however, is not limited to these methods.

### (Transparency)

The present adhesive sheets 1 and 2 are characterized by being transparent. These sheets are distinguished from a non-transparent adhesive sheet such as an adhesive sheet made of a foaming resin or the like.

### <Thickness>

The total thickness of each of the present adhesive sheets 1 and 2 is preferably 50 μm to 1 mm, more preferably 100 μm or more or 500 μm or less.

When the total thickness of each of the present adhesive sheets 1 and 2 is 50 μm or more, each of the sheets can conform to unevenness such as a large print step, and when the total thickness is 1 mm or less, each of the sheets can meet the demand of thinning.

Furthermore, from the viewpoint of a higher print height of the shielding layer on the periphery of a conventional image display device, specifically, from the viewpoint of filling even a step of about 50 μm, the total thickness of each of the present adhesive sheets 1 and 2 is still more preferably 100 μm or more, particularly further preferably 150 μm or more. On the other hand, from the viewpoint of meeting the demand of thinning, the total thickness is preferably 500 μm or less, particularly further preferably 350 μm or less.

### <Base Resin>

As the base resin of each of the present adhesive compositions 1, 2 and 3, a (meth)acrylate type polymer (meaning including a copolymer, hereinafter referred to as “acrylate type (co)polymer”) is preferably used in terms of pressure-sensitive adhesiveness, transparency and weather resistance.

The acrylate type (co)polymer as the base resin can be prepared by appropriately selecting the type and the compositional ratio of an acrylic monomer or a methacrylic monomer for use in polymerization, and also polymerization conditions and the like to thereby appropriately adjust physical properties such as glass transition temperature (Tg) and molecular weight.

Examples of the acrylic monomer or the methacrylic monomer for use in preparation of the acrylate (co)polymer by polymerization include 2-ethylhexyl acrylate, n-octyl acrylate, isooctyl acrylate, n-butyl acrylate, ethyl acrylate, methyl methacrylate and methyl acrylate. Such acrylic monomers and methacrylic monomers, having a hydrophilic group, an organic functional group, or the like, such as hydroxyethyl acrylate, acrylic acid, glycidyl acrylate, acrylamide, acrylonitrile, methacrylonitrile, fluorine-containing acrylate and silicone acrylate can also be used.

In addition, various vinyl monomers such as vinyl acetate, alkyl vinyl ether and hydroxyalkyl vinyl ether, which are copolymerizable with the acrylic monomer or the methacrylic monomer, can also be appropriately used for polymerization.

A known polymerization process such as solution polymerization, emulsion polymerization, bulk polymerization or suspension polymerization can be adopted as the polymerization treatment using such a monomer, and a polymerization initiator such as a thermal polymerization initiator or a photopolymerization initiator can be here used depending on the polymerization process to thereby provide an acrylate copolymer.

The present adhesive compositions 1, 2 and 3 preferably are each a non-solvent system, namely, include no solvent, and can be subjected to hot-melt molding, exhibit a proper pressure-sensitive adhesion force when primarily cured, and have flexibility that enables to conform to unevenness and foreign objects on the surface of a subject to be bonded.

In addition, the base resin of each of the present adhesive compositions 1, 2 and 3, if having a too low molecular weight, cannot exhibit a pressure-sensitive adhesion force and can be so flexible to be poor in handleability even if primarily cured, and on the contrary, if having a too high molecular weight, is made hard when primarily cured, and do not to have flexibility that enables to conform to unevenness and foreign objects on the surface of a subject to be bonded.

From such viewpoints, the mass average molecular weight (Mw) of the base resin is preferably 100000 to 700000, particularly preferably 200000 or more or 600000 or less, above all, particularly preferably 250000 or more or 500000 or less.

As the base resin of each of the present adhesive compositions 1, 2 and 3, an acrylate type (co)polymer having a ratio (Mw/Mn) of the mass average molecular weight (Mw) to the number average molecular weight (Mn) of 2 to 10, preferably 5 to 10, above all, preferably 2.5 or more or 9 or less is further preferably used.

A large value of the mass average molecular weight/number average molecular weight means a broad molecular weight distribution, and in the case where this value is about 2 to 10, such a case is preferable because each of a low molecular weight component and a high molecular weight component exhibits performances corresponding to the molecular weight thereof, such as fluidity, wettability and an aggregation force, and therefore a broad molecular weight distribution tends to impart better processability and pressure-sensitive adhesion performance than a narrower molecular weight distribution (uniform).

Among acrylate type (co)polymers, an acrylate random copolymer is preferably used, and above all, an acrylate random copolymer is preferably used which includes two monomers in which the difference in glass transition temperature (Tg) between respective monomer components forming the random copolymer, namely, the difference in glass transition temperature (also referred to as “Tg”) between respective polymers obtained by polymerization of respective single monomers forming an acrylic ester random copolymer is large.

Herein, the difference in glass transition temperature (Tg) between the two monomer components determined by the differential scanning calorimetry (DSC) method is preferably 25 to 300° C., particularly preferably 40° C. or more or 200° C. or less, above all, particularly preferably 60° C. or more or 180° C. or less, furthermore, still more preferably 100° C. or more or 180° C. or less. Specifically, it is preferable that the glass transition temperature (Tg) of one monomer be −100° C. to 0° C., particularly −80° C. to −20° C., and the glass transition temperature (Tg) of the other monomer component be 0 to 250° C., particularly 20 to 180° C.

The two monomers, in which the difference in glass transition temperature is large, form a copolymer to allow the component having a lower glass transition temperature and the component having a higher glass transition temperature to serve as a fluidity component and as an aggregation component, respectively, thereby making it possible to provide an adhesive sheet having both of flexibility and an aggregation force.

Examples of the copolymerization component having a glass transition temperature (Tg) determined by the differential scanning calorimetry (DSC) method of −100 to 0° C. can include not only alkyl acrylates such as 2-ethylhexyl acrylate, n-octyl acrylate, decyl acrylate, n-butyl acrylate and ethyl acrylate, but also acrylic monomers including an organic functional group, such as 2-ethoxy ethoxy ethyl acrylate, diethylene glycol monobutyl ether acrylate, tetrahydrofurfuryl acrylate, alkoxylated tetrahydrofurfuryl acrylate, 4-hydroxybutyl acrylate glycidyl ether, methoxy polyethylene glycol monoacrylate and caprolactone acrylate.

On the other hand, examples of the comonomer component having a the glass transition temperature (Tg) determined by the differential scanning calorimetry (DSC) method of 0 to 250° C. can include vinyl acetate, styrene, methyl methacrylate, isobornyl(meth)acrylate, dicyclopentadienyl(meth)acrylate, 4-ethoxylated cumylphenol(meth)acrylate, 3,3,5-trimethylcyclohexanol(meth)acrylate, cyclic trimethylol propane formal(meth)acrylate, 2-hydroxypropyl methacrylate, tert-butyl(meth)acrylate, cyclohexyl acrylate, neopentyl acrylate, cetyl acrylate, phenyl acrylate, toluyl acrylate, 2-phenoxyethyl methacrylate, diethylene glycol methyl ether methacrylate, 2-naphthyl acrylate, 2-methoxycarbonyl phenyl acrylate, ethyl methacrylate, n-butyl methacrylate, sec-butyl methacrylate, isobutyl methacrylate, propyl methacrylate, isopropyl methacrylate, stearyl methacrylate, tetrahydrofurfuryl methacrylate, ethoxylated nonylphenol methacrylate, cyclohexyl methacrylate, 4-tert-butyl cyclohexyl methacrylate, benzyl methacrylate, phenethyl methacrylate, glycidyl methacrylate, hydroxyethyl methacrylate, acrylamide, hydroxyethyl acrylamide, N,N-dimethyl acrylamide, N,N-dimethylaminoethyl acrylamide and acrylonitrile.

The ratio of the monomer component having a higher Tg (i.e., monomer in which, when the monomer is singly polymerized, the resulting polymer has a higher glass transition temperature) to the monomer component having a lower Tg (i.e., monomer in which, when the monomer is singly polymerized, the resulting polymer has a lower glass transition temperature) in the acrylate copolymer as the base resin can be adjusted to thereby appropriately adjust the fluidity and aggregation force of each of the present adhesive sheets 1 and 2. For example, in order to impart, to each of the present adhesive sheets 1 and 2, tackiness as a pressure-sensitive adhesive sheet, and ease of wetting to an unevenness surface and foreign objects on surface of a subject to be bonded, the amount of the monomer component having a lower Tg may be increased. In addition, in order to achieve the handling and cuttability of each of the present adhesive sheets 1 and 2, the amount of the monomer component having a higher Tg may be increased.

It is also possible to use a plasticizer to make each of the present adhesive sheets 1 and 2 flexible for a reduction in hardness, or to use an additive such as an oligomer to appropriately adjust the hardness of each of the present adhesive sheets 1 and 2.

### <Ultraviolet Polymerization Initiator (A)>

The ultraviolet polymerization initiator (A) may be any initiator as long as such an initiator generates a radical by irradiation with ultraviolet light such as light in a wavelength region of 300 nm to 380 nm and serves as origination of the polymerization reaction of the base resin.

Accordingly, the present adhesive sheets 1 and 2 each contain the ultraviolet polymerization initiator (A) to thereby have a wavelength absorption region in which an ultraviolet crosslinking reaction is initiated by ultraviolet light, for example, light in any of the wavelength range from 300 nm to 380 nm.

In order that each of the present adhesive sheets 1 and 2 in a B-stage state has still more flexibility than a conventional double-sided adhesive sheet, the ultraviolet polymerization initiator (A) is preferably an ultraviolet polymerization initiator that does not react to light in a visible region. In this case, only the visible light polymerization initiator (B) can be selectively reacted by irradiation with visible light such as light in a wavelength region of 300 nm to 380 nm, and therefore primary curing only by crosslinking by visible light can be performed. The ultraviolet polymerization initiator (A) here is not excited by light and does not contribute to initiation of the primary curing reaction, and therefore a B-stage state in which a sufficient margin for the reaction to ultraviolet light remains can be achieved even after primary curing is performed.

From such viewpoints, the ultraviolet polymerization initiator (A) is preferably one having a property such that radical generation by irradiation with light in a wavelength region (region of a wavelength of 380 nm or more) in visible light hardly occurs. Specifically, one having a molar absorptivity at a wavelength of 365 nm of 10 or more is preferable.

The ultraviolet polymerization initiator (A) is roughly classified into two types with respect to the radical generation mechanism in a (meth)acrylate or vinyl ester system: an “intramolecular cleavage type photopolymerizable initiator” (also referred to as “intramolecular cleavage type”) that can generate a radical by cleavage and decomposition of a single bond of the photopolymerizable initiator itself; and an “intermolecular hydrogen-abstraction type photopolymerizable initiator” (also referred to as “intermolecular hydrogen-abstraction type”) in which the initiator photo-excited and a hydrogen donor in the system can form an exciplex to allow hydrogen of the hydrogen donor to be transferred.

Above all, the ultraviolet polymerization initiator (A) is particularly preferably the intermolecular hydrogen-abstraction type initiator.

The intermolecular hydrogen-abstraction type initiator can be reused as a reaction initiator because, even if once excited, some of the initiator, not reacted, returns to the ground state. Therefore, the intermolecular hydrogen-abstraction type initiator easily remains as active species even after the reaction, as compared with the intramolecular cleavage type initiator. Accordingly, the intermolecular hydrogen-abstraction type initiator is suitably used as a reaction initiator in additional crosslinking (secondary curing) by irradiation with ultraviolet light after bonding. In addition, the intermolecular hydrogen-abstraction type initiator is superior also in that a low molecular weight decomposition product is less produced and the outgas and the eluted substance derived from the decomposition product are less generated, than the intramolecular cleavage type initiator.

The ultraviolet polymerization initiator (A) is preferably an ultraviolet polymerization initiator (A) having a molar absorptivity at a wavelength of 365 nm of 10 or more and having a molar absorptivity at a wavelength of 405 nm of 0.1 or less, and examples can include 2,2-dimethoxy-1,2-diphenylethan-1-one, 1-hydroxycyclohexyl phenyl ketone, 2-hydroxy-2-methyl-1-phenyl-propan-1-one, 1-(4-(2-hydroxyethoxyl)phenyl)-2-hydroxy-2-methyl-1-propan-1-one, 2-hydroxy-1-[4-{4-(2-hydroxy-2-methyl-propionyl)benzyl}phenyl]-2-methyl-propan-1-one, oligo(2-hydroxy-2-methyl-1-(4-(1-methylvinyl)phenyl)propanone), methyl phenyl glyoxylate, 2-methyl-1-(4-methylthiophenyl)-2-morpholinopropan-1-one, benzophenone, 4-methyl-benzophenone, 2,4,6-trimethylbenzophenone, 2,4,6-trimethylbenzophenone, 4-phenylbenzophenone, 3,3′-dimethyl-4-methoxy benzophenone and 4-(1,3-acryloyl-1,4,7,10,13-pentaoxotridecyl)benzophenone. These may be used singly, or as any derivative thereof, or in combinations of two or more.

Above all, benzophenone that is of the intermolecular hydrogen-abstraction type, and derivatives thereof are preferable because of producing no decomposition products even after the reaction and being easily underlying as reaction active species for allowing the composition to be in a B-stage state.

### <Visible Light Polymerization Initiator (B)>

The visible light polymerization initiator (B) may be any initiator as long as such an initiator generates a radical by irradiation with visible light such as light in a wavelength region of 380 nm to 700 nm and serves as origination of the polymerization reaction of the base resin.

The visible light polymerization initiator (B) may generate a radical only by irradiation with visible light, or may generate a radical by irradiation with light in a wavelength region other than a visible region.

The visible light polymerization initiator (B) is preferably a photoinitiator having a molar absorptivity at a wavelength of 405 nm of 10 or more.

The visible light polymerization initiator is also roughly classified into two types with respect to the reactive radical generation mechanism thereof: an intramolecular cleavage type initiator that generates a radical by cleavage and decomposition of a single bond of the initiator itself; and an intermolecular hydrogen-abstraction type initiator (also referred to as “hydrogen-abstraction type”) that allows hydrogen from a hydroxyl group or the like in the system to be excited, to generate a radical.

Above all, the visible light polymerization initiator (B) is particularly preferably the intramolecular cleavage type initiator.

The intramolecular cleavage type initiator is decomposed and converted into another compound in radical generation by irradiation with light, and, if once excited, does not have a function as a reaction initiator. Therefore, in the case where the intramolecular cleavage type initiator is used as the visible light polymerization initiator (B) having an absorption wavelength in a visible light region, such a case is preferable as compared with the case of using the intermolecular hydrogen-abstraction type initiator because, after the adhesive sheet is subjected to primary crosslinking by irradiation with visible light, a visible light reactive photopolymerizable initiator (also referred to as “visible light curable photopolymerizable initiator”) remains as an unreacted residue in the adhesive layer composition, and an unexpected change of the adhesive sheet over time and promotion of crosslinking are not likely caused. Also in terms of coloration specific to the visible light curable photopolymerizable initiator, the intramolecular cleavage type initiator is preferable because any initiator can be appropriately selected which is converted into a reaction decomposition product to thereby allow the absorbance in a visible light region to disappear for color fading.

The visible light polymerization initiator (B) is preferably a visible light polymerization initiator having a molar absorptivity at a wavelength of 405 nm of 10 or more and having a molar absorptivity at a wavelength of 365 nm of 10 or more, and examples can include 2-benzyl-2-dimethylamino-1-(4-morpholinophenyl)butan-1-one, 2-(4-methylbenzyl)-2-dimethylamino-1-(4-morpholinophenyl)butan-1-one, bis(η5-2,4-cyclopentadien-1-yl)-bis(2,6-difluoro-3-(1H-pyrrol-1-yl)phenyl)titanium, bis(2,4,6-trimethylbenzoyl)-phenylphosphine oxide, 2,4,6-trimethylbenzoyl diphenylphosphine oxide, thioxanthone, 2-chlorothioxanthone, 3-methylthioxanthone, 2,4-dimethylthioxanthone, 2-methylanthraquinone, 2-ethylanthraquinone, 2-tert-butylanthraquinone, 2-aminoanthraquinone, 1,2-octanedione and 1-(4-(phenylthio), 2-(o-benzoyloxime)). These may be used singly, or as any derivative thereof, or in combinations of two or more.

Above all, as the intramolecular cleavage type photopolymerizable initiator, bis(2,4,6-trimethylbenzoyl)-phenylphosphine oxide and 2,4,6-trimethylbenzoyl diphenylphosphine oxide are preferable because of being converted into a decomposition product and color-faded after the reaction, and 2,4,6-trimethyl benzoyl diphenylphosphine oxide is further preferable in terms of solubility thereof in a resin.

### (Content of Crosslinking Initiator)

The content of the crosslinking initiator including the ultraviolet polymerization initiator (A) and visible light polymerization initiator (B) is not particularly limited. As a measure, the content is preferably adjusted in a proportion of 0.1 to 10 parts by mass, particularly preferably 0.2 parts by mass or more or 5 parts by mass or less, above all, preferably 0.5 parts by mass or more or 3 parts by mass or less based on 100 parts by mass of the base resin forming each layer. The content, however, may be out of such ranges depending on the balance with other element.

In the present adhesive resin composition 1, the content ratio of the ultraviolet polymerization initiator (A) to the visible light polymerization initiator (B) is preferably 100:1 to 1:1, particularly 50:1 to 1.5:1, further particularly preferably 30:1 to 2:1 from the viewpoint that the changes in physical properties before and after secondary curing can be larger. The ratio, however, may be out of such ranges depending on the balance with other element.

The ratio of the content rate of the visible light polymerization initiator (B) in the outermost layer S2 to the content rate of the visible light polymerization initiator (B) in the intermediate layer S1 is preferably less than 1, more preferably 0.5 or less, particularly preferably 0.3 or less.

The above content ratio is preferable because, after the intermediate layer S1 is primarily cured by visible light, the outermost layer S2 can be in a B-stage state in which a sufficient margin for the reaction to ultraviolet light remains.

### <Crosslinking Agent (C)>

It is possible to perform crosslinking by visible light and crosslinking by ultraviolet light even without the crosslinking agent, depending on the type of the base resin. Accordingly, the crosslinking agent (C) may be if necessary added. The crosslinking agent, however, is preferably contained from the viewpoint that the changes in physical properties before and after secondary curing can be larger.

Examples of the crosslinking agent (C) to be compounded to each of the present pressure-sensitive adhesive compositions 1, 2 and 3 can include ultraviolet curable multifunctional monomers such as 1,4-butanediol di(meth)acrylate, 1,6-hexanediol di(meth)acrylate, 1,9-nonanediol di(meth)acrylate, tricyclodecane dimethanol(meth)acrylate, bisphenol A polyethoxy di(meth)acrylate, bisphenol A polypropoxy di(meth)acrylate, bisphenol F polyethoxy di(meth)acrylate, ethylene glycol di(meth)acrylate, trimethylolpropane trioxyethyl(meth)acrylate, tris(2-hydroxyethyl)isocyanurate tri(meth)acrylate, ε-caprolactone-modified tris(2-hydroxyethyl)isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, tris(acryloxyethyl)isocyanurate, pentaerythritol tetra(meth)acrylate, dipentaerythritol hexa(meth)acrylate, dipentaerythritol penta(meth)acrylate, tripentaerythritol hexa(meth)acrylate, tripentaerythritol penta(meth)acrylate, hydroxybivalic acid neopentyl glycol di(meth)acrylate, di(meth)acrylate of an ε-caprolactone adduct of hydroxy bivalic acid neopentyl glycol, trimethylolpropane tri(meth)acrylate, trimethylolpropane polyethoxy tri(meth)acrylate and ditrimethylolpropane tetra(meth)acrylate, as well as multifunctional acrylic oligomers such as polyester(meth)acrylate, epoxy(meth)acrylate, urethane(meth)acrylate and polyether(meth)acrylate.

Above all, as the crosslinking monomer (crosslinking agent) for use in crosslinking of the acrylate type (co)polymer, for example, a multifunctional(meth)acrylate having three or more (meth)acryloyl groups is preferable in terms of reactivity and the strength of the resulting cured product.

When the amount of the crosslinking agent (C) is large, the reaction rapidly progresses and is difficult to control. Therefore, the amount of the crosslinking agent is preferably adjusted so as to allow crosslinking to be stopped even during crosslinking.

From such a viewpoint, the amount of the crosslinking agent (C) is preferably 0 to 30 parts by mass, particularly preferably 20 parts by mass or less, above all, preferably 10 parts by mass or less, above all, particularly preferably 5 parts by mass or less based on 100 parts by mass of the base resin forming each layer.

### <Tackifier (D)>

The present pressure-sensitive adhesive compositions 1, 2 and 3 may contain if necessary the tackifier (D) being a tackifying resin.

The tackifying resin (D) has a function of adjusting the elastic modulus and the glass transition temperature of each of the present adhesive sheets 1 and 2, and adjusting pressure-sensitive adhesion properties such as a peeling force and tackiness. A high value of peeling resistance is exhibited in the highest energy loss in deformation of a pressure-sensitive adhesive material at the time of peeling off, namely, near the dispersion peak of the Tan δ curve. A pressure-sensitive adhesive composition generally has a lower peak temperature of Tan δ than room temperature, and therefore the tackifying resin (D) can be added to thereby increase the glass transition temperature of the entire composition, thereby increasing an apparent peeling resistance in the range from room temperature to a high temperature.

Accordingly, when an apparent peeling resistance is achieved, the tackifying resin (D) may also be contained.

The softening temperature of the tackifying resin (D) is preferably 60° C. to 150° C., particularly preferably 60° C. to 130° C. When the softening temperature is too high, compatibility with the (meth)acrylate copolymer being a pressure-sensitive adhesive main agent tends to be poor, and when the softening temperature is too low, the effect of adjusting pressure-sensitive adhesion properties is hardly exerted, and the durability of the adhesive sheet under a high temperature environment may be impaired.

The tackifying resin having a softening temperature of 60° C. to 150° C. can include tackifying resins such as a styrene resin, a rosin resin, a terpene resin and an aliphatic hydrocarbon type resin from the viewpoints of transparency, availability, compatibility with the (meth)acrylate copolymer, and the like. These can be used singly or in combinations of two or more.

Above all, a hydrogenated rosin ester resin is preferable from the viewpoint of having heat yellowing resistance and compatibility in a wide range of compounding ratios.

The hydrogenated rosin ester resin is available from ARAKAWA CHEMICAL INDUSTRIES, LTD. (Pinecrystal), Pinova Corp. (Piccolyte), or the like.

### <Others>

Each of the present pressure-sensitive adhesive compositions 1, 2 and 3 may contain a known component compounded in a usual pressure-sensitive adhesive composition, as a component other than the above components. For example, various additives such as an antioxidant, an antiaging agent and a moisture absorbent can also be if necessary appropriately compounded.

In addition, a reaction catalyst (tertiary amine type compound, quaternary ammonium type compound, tin laurate compound, or the like) may also be if necessary appropriately added.

### <Applications of Present Adhesive Sheets 1 and 2>

Each of the present adhesive sheets 1 and 2 not only is transparent and has adhesiveness, but also can conform to a step portion on a bonding surface to fill every corner therewith, can allow strain generated in each of the adhesive sheets to be relaxed, and furthermore can maintain foaming resistance under a high-temperature and/or high-humidity environment without impairment of workability in handling. Accordingly, each of the present adhesive sheets 1 and 2 can be suitably used for bonding a transparent panel such as a protection panel or a touch panel to an image display panel in a flat image display device, in which an image display panel such as LCD, PDP or EL is used, such as a personal computer, a personal digital assistant (PDA), a game machine, a television (TV), a car navigation system, a touch panel or a pen tablet.

For example, a configuration is adopted in a display screen or the like of a mobile phone, in which a polarizing film or the like is laminated on a liquid crystal panel display (LCD), and a plastic protection panel is laminated thereon with an adhesive sheet interposed therebetween. Here, a print portion (about 5 μm to 80 μm in thickness) for shielding is provided on the periphery portion of the rear surface of the protection panel, and if an adhesive does not sufficiently come into the internal corner of a step portion formed on the edge of the print portion for shielding, air bubbles remain to result in deterioration in visibility of the screen.

Each of the present adhesive sheets 1 and 2, even when not only such a step of about 5 μm to 20 μm but also a step of about 50 to 80 μm is present, can conform to these steps to fill every corner therewith for bonding and attaching without any air bubbles remaining. Furthermore, each of the present adhesive sheets 1 and 2 can be used for bonding and attaching even under a high temperature environment of, for example, about 85° C. without foaming, and is extremely excellent in conformability to unevenness. Therefore, each of the present adhesive sheets 1 and 2 can be suitably used for bonding image display device-constituting members provided with a step portion such as a large print step and an unevenness portion on a bonding surface.

In addition, each of the present adhesive sheets 1 and 2 is excellent in shape retaining properties and can be processed to any shape in advance, and therefore is preferably cut in advance in accordance with an image display panel.

The cutting method here is generally a cutting method by punching with a Thomson blade, or cutting with a super cutter or laser, and is more preferably a method in which any one of front and rear releasing films remain in a flame shape so as to easily peel releasing films, and is half-cut.

More specifically, each of the present adhesive sheets 1 and 2 can be used to directly bond a protection panel and an image display panel, or a touch panel body and an image display panel, or a touch panel body and a protection panel to prepare a laminate for constituting an image display device, or an image display device.

### <Process for Producing Laminate for Constituting Image Display Device>

Next, the process for producing a laminate for constituting an image display device (referred to as “present laminate for constituting an image display device”), having a configuration in which an image display device-constituting member is laminated on at least one side of the present adhesive sheet 1 or 2 will be described.

The present laminate for constituting an image display device encompasses, in addition to a laminate having a configuration in which an image display device-constituting member is laminated on each of both sides of the present adhesive sheet 1 or 2, a laminate having a configuration in which an image display device-constituting member is laminated on one side of the present adhesive sheet 1 or 2 and a release sheet or the like is laminated on the other side.

The present laminate for constituting an image display device can be produced through at least the following steps (1) and (2):

(1) a step of molding an uncrosslinked adhesive composition to a monolayer or multilayer sheet, and irradiating the adhesive composition with visible light to crosslink the adhesive composition by visible light, thereby forming the present adhesive sheet 1 or 2 in a B-stage state; and
(2) a step of laminating an image display device-constituting member on at least one side of the present adhesive sheet 1 or 2 in a B-stage state, and irradiating the transparent double-sided adhesive sheet with ultraviolet light, with the image display device-constituting member interposed, for crosslinking by ultraviolet light.

### (Step (1))

In step (1), the present adhesive sheet 1 or 2 may be prepared by the above-mentioned method. For example, each of uncrosslinked present adhesive compositions 1, 2 and 3 may be molded to a monolayer or multilayer sheet between two transparent release sheets, and the adhesive composition may be irradiated with visible light through at least one side of the sheet to crosslink the adhesive composition by visible light.

Here, for example, each of the present adhesive compositions 1, 2 and 3 can also be heated and molten (hot-melt), and applied to a transparent release resin sheet to form a monolayer or multilayer sheet.

In irradiation with visible light, the irradiation is preferably conducted with visible light not substantially including light of a wavelength in an ultraviolet region, for example, light of a wavelength of less than 380 nm.

As the method of irradiation with visible light not substantially including light of a wavelength in an ultraviolet region, a method may be adopted in which the irradiation is conducted using a light source that emits only visible light not including light of a wavelength in an ultraviolet region, or conducted via a filter not transmitting light of a wavelength in an ultraviolet region, as described above.

Examples can include a method of irradiating the adhesive composition with visible light with a transparent release sheet having a light transmittance at a wavelength of 380 nm of less than 10% and a light transmittance at a wavelength of 405 nm of 80% or more interposed.

The phrase “not substantially including” here is intended to encompass a case where light in an ultraviolet region is more or less included because such a case may occur even if the light is purposely filtered, and, for example, light, if having a ratio of the light intensity in a wavelength region of less than 380 nm (for example, 350 nm in wavelength) to the light intensity in a wavelength region of 380 nm or more (for example, 410 nm in wavelength), of less than 10%, is considered not to substantially include light in an ultraviolet region.

In step (1), in order to adjust the degree of crosslinking by visible light, the degree of crosslinking by visible light can also be adjusted not only by a method of controlling the amount of irradiation with visible light, but also by irradiation with visible light with a transparent release sheet interposed for partial shielding of transmission of visible light.

As a transparent release sheet usable for such a purpose, namely, a transparent release sheet having a function of partially shielding transmission of visible light, for example, a polyester type, polypropylene type, or polyethylene type cast film or stretched film coated with a silicone resin and subjected to a release treatment can be appropriately selected and used, and examples can particularly include a releasing film having a different peeling force and a releasing film having a different thickness.

The thickness of the transparent double-sided adhesive sheet, the amount of irradiation with visible light, the irradiation wavelength, the irradiation apparatus, and the like may be here appropriately adjusted.

### (Step (2))

In step (2), an image display device-constituting member is laminated on at least one side of the present adhesive sheet 1 or 2 in a B-stage state obtained in step (1), and the transparent double-sided adhesive sheet is irradiated with ultraviolet light, with the image display device-constituting member interposed, for crosslinking by ultraviolet light.

Thus, the transparent double-sided adhesive sheet in a B-stage state can be irradiated with ultraviolet light, with the image display device-constituting member interposed, for crosslinking by ultraviolet light, thereby tightly crosslinking the transparent double-sided adhesive sheet, and allowing the transparent double-sided adhesive sheet to tightly adhere to the image display device-constituting member.

The image display device-constituting member here can include, for example, a touch panel, an image display panel, a surface protection panel and a polarizing film, and may be any one of them or a laminate including a combination of two or more of them.

As described above, the image display device-constituting member may be laminated on one side of the present adhesive sheet 1 or 2 and a release sheet or the like may be laminated on the other side thereof.

In step (2), it is necessary to perform irradiation with ultraviolet light, with the image display device-constituting member interposed, to allow the ultraviolet crosslinking reaction to occur. For this purpose, a sufficient amount of light of a wavelength effective for exciting the photoinitiator in each of the present adhesive sheets 1 and 2 to generate a radical is required to travel, and therefore when the transparent double-sided adhesive sheet is irradiated with ultraviolet light, with the image display device-constituting member interposed, the image display device-constituting member preferably has an ultraviolet transmittance at a certain level or more.

Specifically, for example, when a glass plate is laminated as the image display device-constituting member on one side of the present adhesive sheet 1 or 2 to be irradiated with ultraviolet light, the ultraviolet transmittance of the glass plate is preferably at a certain level or more. In addition, for example, when a glass plate is laminated on one side of the present adhesive sheet 1 or 2 and a protection sheet is laminated on the other side thereof, the ultraviolet transmittance of at least any of the glass plate or the protection sheet is preferably at a certain level or more.

Accordingly, the ultraviolet transmittance of the image display device-constituting member in irradiation of the transparent double-sided adhesive sheet with ultraviolet light, with the image display device-constituting member interposed, namely, the light transmittance in a wavelength range of UV-A wave, from 300 nm to 380 nm, is preferably 20% or more, particularly preferably 30% or more, above all, particularly still more preferably 40% or more.

Examples of a member that can have such a light transmittance can include members made of a polycarbonate resin, an acrylic resin, a polyvinyl chloride resin, a polyester resin, a cyclic polyolefin resin, a styrene resin, and the like. According to the process for producing a laminate for constituting an image display device of the present invention, the change in dimension due to the changes in temperature and humidity of a plastic member, and foaming due to discharge or penetration of the outgas can be suppressed, and therefore, not only the resin members made of a polycarbonate resin, an acrylic resin, and a cyclic polyolefin resin, but also resin members made of a triacetyl cellulose resin and the like can also be used for the resin member for constituting a laminate.

### (Present Laminate for Constituting Image Display Device)

Examples of the image display device-constituting member that can be used for the above production process can include constituent members of an image display device such as a personal computer, a personal digital assistant (PDA), a game machine, a television (TV), a car navigation system, a touch panel or a pen tablet, for example LCD, PDP or EL.

As one specific example, a polarizing film or the like may be laminated on a liquid crystal panel display (LCD), and a plastic protection panel may be laminated thereon with a pressure-sensitive adhesive or sheet interposed, in an image display device of a mobile phone. A PVA (polyvinyl alcohol) or triacetyl cellulose resin may be here used as a constituting material of the polarizing film, and such a resin has been found to easily discharge the outgas.

Then, a laminate having a configuration of protection panel/present adhesive sheets 1 and 2/polarizing film can be prepared to thereby effectively suppress foaming due to the outgas discharged from a protection panel and a polarizing film, even when used at high temperatures.

Other examples of the configuration of the present laminate can include configurations of release sheet/present adhesive sheets 1 and 2/touch panel, release sheet/present adhesive sheets 1 and 2/protection panel, release sheet/present adhesive sheets 1 and 2/liquid crystal panel, liquid crystal panel/present adhesive sheets 1 and 2/touch panel, liquid crystal panel/present adhesive sheets 1 and 2/protection panel, liquid crystal panel/present adhesive sheets 1 and 2/touch panel/present adhesive sheets 1 and 2/protection panel, polarizing film/present adhesive sheets 1 and 2/touch panel, and polarizing film/present adhesive sheets 1 and 2/touch panel/present adhesive sheets 1 and 2/protection panel.

### <Description of Words, and the Like>

Herein, the “sheet” generally means a thin and flat product that has a small thickness relative to its length and width according to the definition of JIS, and the “film” generally means a thin and flat product that has an extremely small thickness relative to its length and width, in which the maximum thickness is arbitrarily limited, and that is usually supplied in the form of roll (Japanese Industrial Standards JISK6900). The boundary between the sheet and the film, however, is uncertain, and it is not necessary to literally distinguish both the sheet and the film in the present invention. Therefore, in the present invention, even when the “film” is mentioned, the “sheet” is encompassed, and even when the “sheet” is mentioned, the “film” is encompassed.

In addition, when the “panel” such as an image display panel and a protection panel is expressed, a plate, a sheet and a film are encompassed.

Herein, when the description “X to Y” (X and Y are arbitrary numbers) is made, not only the meaning “X or more and Y or less”, but also the meaning “preferably more than X” or “preferably less than Y” is encompassed, unless particularly noted.

In addition, when the description “X or more” (X is an arbitrary number) is made, the meaning “preferably more than X” is also encompassed unless particularly noted, and the description “Y or less” (Y is an arbitrary number) is made, the meaning “preferably less than Y” is also encompassed unless particularly noted.

### EXAMPLES

Hereinafter, the present invention is described in more detail with reference to Examples and Comparative Examples. The present invention, however, is not limited thereto.

### (Intermediate Layer Composition A)

One kilogram of an acrylate copolymer (Mw: 400000, Mn: 90000, Mw/Mn: 4.4) obtained by random copolymerization of 75 parts by mass of 2-ethylhexyl acrylate (Tg: −70° C.), 20 parts by mass of vinyl acetate (Tg: 32° C.) and 5 parts by mass of acrylic acid (Tg: 105° C.) was uniformly mixed with 250 g of an ultraviolet curing resin, propoxylated pentaerythritol triacrylate (“ATM-4PL” manufactured by Shin Nakamura Chemical Co., Ltd.) as a crosslinking agent, 3 g of 2,4,6-trimethylbenzoyl diphenylphosphine oxide (“Lucirin TPO” manufactured by BASF, molar absorptivity at 365 nm: 160, molar absorptivity at 405 nm: 60) as a visible light polymerization initiator, and 10 g of 4-methylbenzophenone (SpeedCureMBP manufactured by Lambson Ltd., molar absorptivity at 365 nm: 30, molar absorptivity at 405 nm: 0.1 or less) as an ultraviolet polymerization initiator, to prepare intermediate layer composition A.

### (Intermediate Layer Composition B)

Intermediate layer composition B was prepared in the same manner as in intermediate layer composition A except that 20 g of 4-methylbenzophenone (SpeedCureMBP manufactured by Lambson Ltd., molar absorptivity at 365 nm: 30, molar absorptivity at 405 nm: 0.1 or less) being an ultraviolet polymerization initiator was used as a photopolymerizable initiator instead of 2,4,6-trimethylbenzoyl diphenylphosphine oxide and 4-methylbenzophenone in intermediate layer composition A.

### (Intermediate Layer Composition C)

Intermediate layer composition C was prepared in the same manner as in intermediate layer composition A except that 10 g of 2,4,6-trimethylbenzoyl diphenylphosphine oxide (“Lucirin TPO” manufactured by BASF, molar absorptivity at 365 nm: 160, molar absorptivity at 405 nm: 60) being a visible light polymerization initiator was used as a photopolymerizable initiator instead of 2,4,6-trimethylbenzoyl diphenylphosphine oxide and 4-methylbenzophenone in intermediate layer composition A.

### (Adhesive Layer Composition A)

One kilogram of an acrylate copolymer (Mw: 500000, Mn: 90000, Mw/Mn: 5.6) obtained by random copolymerization of 75 parts by mass of 2-ethylhexyl acrylate (Tg: −70° C.), 20 parts by mass of vinyl acetate (Tg: 32° C.) and 5 parts by mass of acrylic acid (Tg: 105° C.) was mixed with 50 g of an ultraviolet curing resin, propoxylated pentaerythritol triacrylate (“ATM-4PL” manufactured by Shin Nakamura Chemical Co., Ltd.) as a crosslinking agent and 15 g of 4-methylbenzophenone (SpeedCureMBP manufactured by Lambson Ltd., molar absorptivity at 365 nm: 30, molar absorptivity at 405 nm: 0.1 or less) as an ultraviolet polymerization initiator, to prepare adhesive layer composition A.

### (Adhesive Layer Composition B)

One kilogram of an acrylate copolymer (Mw: 350000, Mn: 70000, Mw/Mn: 5.0) obtained by random copolymerization of 69 parts by mass of butyl acrylate (Tg: −55° C.), 30 parts by mass of vinyl acetate (Tg: 32° C.) and 1 part by mass of acrylic acid (Tg: 105° C.) was mixed with 70 g of propoxylated pentaerythritol triacrylate (“ATM-4PL” manufactured by Shin Nakamura Chemical Co., Ltd.) as a crosslinking agent, 100 g of a hydrogenated rosin resin (“Pinecrystal KR311” manufactured by ARAKAWA CHEMICAL INDUSTRIES, LTD., softening temperature: 77° C.) as a tackifier, and 20 g of 4-methylbenzophenone (SpeedCureMBP manufactured by Lambson Ltd., molar absorptivity at 365 nm: 30, molar absorptivity at 405 nm: 0.1 or less) as an ultraviolet polymerization initiator, to prepare adhesive layer composition B.

### (Adhesive Layer Composition C)

One kilogram of an acrylate copolymer (Mw: 400000, Mn: 90000, Mw/Mn: 4.4) obtained by random copolymerization of 75 parts by mass of 2-ethylhexyl acrylate (Tg: −70° C.), 20 parts by mass of vinyl acetate (Tg: 32° C.) and 5 parts by mass of acrylic acid (Tg: 105° C.) was mixed with 20 g of 4-methylbenzophenone molar absorptivity (365 nm: 30, molar absorptivity at 405 nm: 0.1 or less) as an ultraviolet polymerization initiator, to prepare adhesive layer composition C.

### (Adhesive Layer Composition D)

Adhesion composition D was prepared in the same manner as in adhesion composition A except that 10 g of 2,4,6-trimethylbenzoyl diphenylphosphine oxide (“Lucirin TPO” manufactured by BASF, molar absorptivity at 365 nm: 160, molar absorptivity at 405 nm: 60) was compounded as a photopolymerizable initiator instead of 4-methylbenzophenone in adhesion composition A.

### (Adhesive Layer Composition E)

To 1 kg of an acrylate copolymer (Mw: 150000, Mn: 50000, Mw/Mn: 3.0) obtained by random copolymerization of 88 parts by mass of 2-ethylhexyl acrylate (Tg: −70° C.), 11.5 parts by mass of acrylic acid (Tg: 105° C.) and 0.5 parts by mass of 4-acryloyloxy ethoxybenzophenone was added 1 g of 2,4,6-trimethylbenzoyl diphenylphosphine oxide (“Lucirin TPO” manufactured by BASF, molar absorptivity at 365 nm: 160, molar absorptivity at 405 nm: 60) as a photopolymerizable initiator, to prepare adhesive layer composition E.

### Example 1

An UV-shielding polyethylene terephthalate film subjected to a release treatment (“O700E100” manufactured by Mitsubishi Plastics, Inc.) (the light transmittance at a wavelength of 380 nm was 0.7% and the light transmittance at a wavelength of 405 nm was 87%) was prepared.

Co-extrusion to the one side of the releasing film treated so as to be able to be peeled was conducted so that adhesive layer composition A/intermediate layer composition A/adhesive layer composition A=50 μm/50 μm/50 μm was satisfied, to form a sheet, and the above-mentioned releasing film was laminated on the surface of the sheet to prepare a laminate.

The laminate was irradiated with light by a high-pressure mercury lamp through the front and rear sides thereof, with releasing films 1 and 2 interposed, so that the accumulated amount of light at a wavelength of 405 nm was 1000 mJ, for crosslinking by visible light, to prepare transparent double-sided adhesive sheet 1 (total thickness: 150 μm) in a B-stage state. Since light at a wavelength of 380 nm or less was here shielded by the UV-shielding polyethylene terephthalate film, only light at a wavelength of 380 nm or more (visible light) reached the transparent double-sided pressure-sensitive adhesive sheet in reality.

### Example 2

Transparent double-sided adhesive sheet 2 in a B-stage state (total thickness: 150 μm) was prepared in the same manner as in Example 1 except that co-extrusion was conducted so that adhesive layer composition B/intermediate layer composition A/adhesive layer composition B=50 μm/50 μm/50 μm was satisfied, to form a sheet in Example 1.

### Comparative Example 1

Co-extrusion to one side of a polyethylene terephthalate film subjected to a release treatment (“Byna 100GT” manufactured by FUJIMORI KOGYO CO., LTD.: the light transmittance at a wavelength of 365 nm was 87% and the light transmittance at a wavelength of 405 nm was 90%) was conducted so that adhesive layer composition C/intermediate layer composition B/adhesive layer composition C=40 μm/70 μm/40 μm was satisfied, to form a sheet, and a polyethylene terephthalate film subjected to a release treatment (“MRF75” manufactured by Mitsubishi Plastics, Inc.; the light transmittance at a wavelength of 365 nm was 88% and the light transmittance at a wavelength of 405 nm was 90%) was laminated on the surface of the sheet to prepare a laminate.

The laminate was irradiated by a high-pressure mercury lamp through the front and rear sides thereof, with the polyethylene terephthalate film interposed, so that the accumulated amount of light at a wavelength of 365 nm was 1000 mJ, for crosslinking by ultraviolet light, to prepare transparent double-sided adhesive sheet 1 (total thickness: 150 μm) in a B-stage state.

### Comparative Example 2

Transparent double-sided adhesive sheet 4 in a B-stage state (total thickness: 150 μm) was prepared in the same manner as in Example 1 except that co-extrusion was conducted so that adhesion composition D/intermediate layer composition C/adhesion composition D=50 μm/50 μm/50 μm was satisfied, to form a sheet in Example 1.

### Comparative Example 3

Extrusion to the one side of a polyethylene terephthalate film subjected to a release treatment (“Byna 100GT” manufactured by FUJIMORI KOGYO CO., LTD.) was conducted so that adhesion composition D=150 μm was satisfied, to form a sheet, and a polyethylene terephthalate film subjected to a release treatment (“MRF75” manufactured by Mitsubishi Plastics, Inc.) was laminated on the surface of the sheet to prepare uncured transparent double-sided adhesive sheet 5 (total thickness: 150 μm).

### <Preparation of Laminate for Constituting Image Display Device>

As an alternative member of an image display device-constituting member having a large print step, prepared was a glass substrate for evaluation (the light transmittance in the wavelength range from 300 nm to 380 nm was 90% or more) in which a white print of 10 mm in width and 80 μm in thickness was applied to the periphery portion of soda-lime glass of 60 mm×90 mm×0.5 mm in thickness to form a print step of 80 μm on the periphery portion.

Then, one releasing film of each of transparent double-sided adhesive sheets 1 to 4 cut to a predetermined size was peeled to expose a pressure-sensitive adhesive side, the pressure-sensitive adhesive side was press-bonded to the print step portion of the glass substrate with heated to 80° C. under reduced pressure (absolute pressure: 5 kPa) so as to cover the print step portion, and thereafter each of transparent double-sided adhesive sheets 1 to 4 was irradiated by a high-pressure mercury lamp, with the glass substrate interposed, so that the accumulated amount of light at a wavelength of 365 nm was 1000 mJ, for crosslinking by ultraviolet light, to prepare each of laminates 1 to 4 for constituting an image display device.

### <Evaluations>

The following evaluations were performed with respect to transparent double-sided adhesive sheets 1 to 5 obtained in Examples and Comparative Examples.

### (Dynamic Storage Elastic Modulus (E′) at 60° C. Determined by Tension Method)

The dynamic storage elastic modulus (E′) at 60° C. determined by a tension method was determined as follows: each of transparent double-sided adhesive sheets 1 to 5 obtained in Examples and Comparative Examples was cut to a specimen size of 4 mm in width×15 mm in length, and the dynamic storage elastic modulus E′ at 60° C. by a tension method was measured using a dynamic viscoelasticity measurement apparatus (itkDVA-200 manufactured by IT Keisoku Seigyo Co., Ltd.) in a tensile mode of a vibrational frequency of 1 Hz at a measurement temperature of 0° C. to 100° C. and a rate of temperature rise of 3° C./min.

### (Dynamic Storage Elastic Modulus (G′) at 60° C. Determined by Shear Method)

The dynamic storage elastic modulus (G′) at 60° C. determined by a shear method was determined as follows: a plurality of sheets of each of transparent double-sided adhesive sheets 1 to 5 obtained in Examples and Comparative Examples were used and laminated so that the thickness was 1 mm to 2 mm, and the resulting laminate was punched to a round shape having a diameter of 20 mm to provide a measurement specimen, and the dynamic storage elastic modulus G′ at 60° C. by a shear method was measured using a rheometer (“MARS” manufactured by EKO Instruments) by a pressure-sensitive adhesion tool with a parallel plate having a diameter of 25 mm at a strain of 0.5%, a frequency of 1 Hz, a temperature of −50 to 200° C. and a rate of temperature rise of 3° C./min.

### (Evaluations of Cutting Processability/Storage Stability)

Each of transparent double-sided adhesive sheets 1 to 5 was cut, with the releasing film being laminated, to 100 sheets using a Thomson punching machine with a Thomson blade of 55 mm×85 mm. The shape of each end was observed immediately after the cutting and after the 100 sheets cut were laminated and stored under an environment of 25° C. and a humidity of 50% for one week.

A case where a protrusion of the adhesive or collapse of each end was observed in 10 sheets or more immediately after bonding or after storage was rated as “x (Poor)”, and a case where neither the protrusion of the adhesive nor the collapse of each end was observed in 10 sheets or more was considered “◯ (Good)”.

### (Test of Conformability to Print Step)

When each of laminates 1 to 4 for constituting an image display device was prepared as described above, the appearance of each of laminates 1 to 4 was visually observed, and a case where lifting or peeling of the transparent double-sided adhesive sheet occurred near a print step was rated as “x (Poor)”, a case where the lifting did not occur, but line nonuniformity or optical nonuniformity was observed in an opening near a print step was rated as “Δ (Fair)”, and a case where neither the lifting nor the peeling was observed was rated as “◯ (Good)”.

### (Foaming Resistance Test)

As an alternative member of an image display device-constituting member having a large print step, prepared was a glass substrate for evaluation (the light transmittance in the wavelength range from 300 nm to 380 nm of an opening was 90% or more) in which a white print of 10 mm in width and 80 μm in thickness was applied to the periphery portion of soda-lime glass of 60 mm×90 mm×0.5 mm in thickness to form a print step of 80 μm on the periphery portion.

The glass substrate for evaluation was thus prepared for 50 sheets each, and each of transparent double-sided adhesive sheets 1 to 5 was irradiated with ultraviolet light, with the glass substrate to which the print was applied interposed, so that the accumulated amount of ultraviolet light at 365 nm reached 2000 mJ/cm2, to prepare each foaming resistance test sample.

Each sample was left to still stand at a normal state (temperature: 23° C.; humidity: 50%) for one day and thereafter aged in a constant temperature/constant humidity machine at a temperature of 85° C. and a humidity of 25% for 6 hours, and the appearance thereof after the aging was visually observed.

A case where new lifting or foaming occurred after the aging in 5 sheets or more was rated as “x (Poor)”, a case where new lifting or foaming occurred after the aging in 5 sheets or less was rated as “A (Fair)”, and a case where neither new lifting nor foaming occurred was rated as “◯ (Good)”.

TABLE 1

| | | | Comparative | Comparative | Comparative |
|---|---|---|---|---|---|
| | Example 1 | Example 2 | Example 1 | Example 2 | Example 3 |
| G′ (kPa) at 60° C. of | 62 | 62 | 40 | 77 | — |
| intermediate layer | | | | | |
| G′ (kPa) at 60° C. of | 5.7 | 6.1 | 11 | 12 | — |
| adhesive layer | | | | | |
| E′ (kPa) at 60° C. of | 640 | 660 | 110 | 160 | 54 |
| sheet | | | | | |
| G′ (kPa) at 60° C. of | 32 | 22 | 20 | 26 | 22 |
| sheet | | | | | |
| E′/G′ at 60° C. of | 20 | 30 | 5.5 | 6.2 | 2.5 |
| sheet | | | | | |
| Processability/Storage | ∘ (Good) | ∘ (Good) | ∘ (Good) | ∘ (Good) | x (Poor) |
| stability | | | | | |
| Conformability to | ∘ (Good) | ∘ (Good) | Δ (Fair) | x (Poor) | ∘ (Good) |
| print step | | | | | |
| Foaming resistance | ∘ (Good) | ∘ (Good) | Δ (Fair) | x (Poor) | ∘ (Good) |
| reliability | | | | | |
| Overall rating | ∘ (Good) | ∘ (Good) | Δ (Fair) | x (Poor) | x (Poor) |

### <Discussion>

It was found that both of adhesive sheets 1 and 2 (Examples 1 and 2), in which the photopolymerizable initiator (A) reactive to ultraviolet light and the polymerization initiator (B) high in sensitivity to visible light were used in combination to adjust the value E′/G′ to 10 or more, could allow strain generated in a portion in contact with a step portion to be relaxed, while having excellent cutting processability and storage stability, and could suppress an adverse effect on optical properties. Furthermore, both of adhesive sheets 1 and 2 could be in a B-stage state where a sufficient margin for crosslinking by ultraviolet light remained, and therefore could be irradiated with ultraviolet light after bonding, with the member interposed, to thereby provide a laminate excellent in foaming resistance reliability.

Adhesive sheet 3 (Comparative Example 1) containing no visible light curable photopolymerizable initiator (B) could achieve excellent processability and storage stability by primary crosslinking by ultraviolet light, but caused impairment of fluidity in bonding and therefore could not allow strain generated in a portion in contact with a step portion to be sufficiently relaxed as compared with Examples in which bonding to a print step could be conducted without any air bubble, and as a result, slight line nonuniformity was left near an unevenness portion.

In addition, the sensitivity to the secondary crosslinking reaction by ultraviolet light was impaired by primary crosslinking, and as a result, foaming resistance reliability was poor as compared with those in Examples.

Adhesive sheet 4 (Comparative Example 2) contained only a visible light curable photopolymerizable initiator, in which the crosslinking reaction in primary curing excessively progressed to cause impairment of flexibility in bonding, and as a result, was poor in conformability to unevenness. In addition, almost no margin for secondary crosslinking remained, and foaming resistance reliability was not achieved.

Adhesive sheet 5 (Comparative Example 3) having a value E′/G′ of 10 or less hardly satisfied both of handleability and conformability to unevenness, and was poor in cutting processability while being excellent in flexibility and excellent in responsiveness to a print step. In addition, adhesive sheet 5 was not subjected to primary crosslinking, and therefore easily caused permanent deformation in the entire sheet in storage and was poor in stability.

1. A transparent double-sided adhesive sheet in a B-stage state, wherein
first, the transparent double-sided adhesive sheet comprises at least one (meth)acrylate (co)polymer, an ultraviolet polymerization initiator (A) having a molar absorptivity at a wavelength of 365 nm of 10 or more and a molar absorptivity at a wavelength of 405 nm of 0.1 or less, and a visible light polymerization initiator (B) having a molar absorptivity at a wavelength of 405 nm of 10 or more, and
second, a value (E′/G′) obtained by dividing a dynamic storage elastic modulus (E′) at 60° C. determined by a tension method, by a dynamic storage elastic modulus (G′) at 60° C. determined by a shear method is 10 or more.

2. The transparent double-sided adhesive sheet according to claim 1, further comprising a multifunctional (meth)acrylate resin (C) as a crosslinking agent.

3. The transparent double-sided adhesive sheet according to claim 1, further comprising a tackifier (D) containing a resin having a softening temperature of 60° C. to 150° C.

4. The transparent double-sided adhesive sheet according to claim 1, being a laminated sheet provided with
an intermediate layer S1 comprising the at least one (meth)acrylate (co)polymer and the visible light polymerization initiator (B) having a molar absorptivity at a wavelength of 405 nm of 10 or more, and
an outermost layer S2 comprising the at least one (meth)acrylate (co)polymer, and the ultraviolet polymerization initiator (A) having a molar absorptivity at a wavelength of 365 nm of 10 or more and a molar absorptivity at a wavelength of 405 nm of 0.1 or less.

5. The transparent double-sided adhesive sheet according to claim 4, wherein a ratio (outermost Bm/intermediate Bm) of the number of parts by mass of the visible light polymerization initiator (B) (outermost Bm) based on 100 parts by mass of the (meth)acrylate (co)polymer in the outermost layer S2 to the number of parts by mass of the visible light polymerization initiator (B) (intermediate Bm) based on 100 parts by mass of the (meth)acrylate (co)polymer in the intermediate layer S1 is less than 1.

6. The transparent double-sided adhesive sheet according to claim 1, wherein the ultraviolet polymerization initiator (A) is an intermolecular hydrogen-abstraction type photoinitiator, and the visible light polymerization initiator (B) is a cleavage type photopolymerizable initiator.

7. A laminate for constituting an image display device, wherein the laminate has a configuration obtained by laminating an image display device-constituting member on at least one side of the transparent double-sided adhesive sheet according to claim 1, and irradiating the transparent double-sided adhesive sheet with light including ultraviolet light, with the image display device-constituting member interposed, to crosslink the transparent double-sided adhesive sheet by ultraviolet light.

8. The laminate for constituting an image display device according to claim 7, wherein the image display device-constituting member is any one of the group comprising a touch panel, an image display panel, a surface protection panel and a polarizing film, or a laminate comprising a combination of two or more thereof.

9. An image display device constituted using the laminate according to claim 8.

10. A process for producing a laminate for constituting an image display device, the laminate having a configuration obtained by laminating an image display device-constituting member on at least one side of a transparent double-sided adhesive sheet,
the process comprising at least the following steps (1) and (2):
(1) a step of molding an uncrosslinked adhesive composition to a monolayer or multilayer sheet, and irradiating the adhesive composition with visible light to crosslink the adhesive composition by visible light, thereby forming a transparent double-sided adhesive sheet in a B-stage state; and
(2) a step of laminating an image display device-constituting member on at least one side of the transparent double-sided adhesive sheet in a B-stage state, and irradiating the transparent double-sided adhesive sheet with light including ultraviolet light, with the image display device-constituting member interposed, for crosslinking by ultraviolet light.

11. The process for producing a laminate for constituting an image display device according to claim 10, wherein the uncrosslinked adhesive composition comprises an ultraviolet polymerization initiator that initiates crosslinking only by light in an ultraviolet region, and a visible light polymerization initiator that initiates crosslinking by light in a visible region.

12. The process for producing a laminate for constituting an image display device according to claim 10, comprising irradiating the adhesive composition with visible light not substantially including light at a wavelength of less than 380 nm, to crosslink the adhesive composition by visible light, in step (1).

13. The process for producing a laminate for constituting an image display device according to claim 10, comprising molding the uncrosslinked adhesive composition to a monolayer or multilayer sheet between two transparent release sheets, and irradiating the adhesive composition with visible light through at least one side of the sheet, to crosslink the adhesive composition by visible light, in step (1).

14. The process for producing a laminate for constituting an image display device according to claim 10, wherein the transparent double-sided adhesive sheet in a B-stage state has a wavelength absorption region, in which an ultraviolet crosslinking reaction is initiated, in any of a wavelength range from 300 nm to 380 nm.

15. The process for producing a laminate for constituting an image display device according to claim 10, wherein the image display device-constituting member has a light transmittance of 20% or more in a wavelength range from 300 nm to 380 nm in irradiation of the transparent double-sided adhesive sheet in a B-stage state with ultraviolet light, with the image display device-constituting member interposed, in step (2).

16. The process for producing a laminate for constituting an image display device according to claim 10, wherein the image display device-constituting member is any one of the group comprising a touch panel, an image display panel, a surface protection panel and a polarizing film, or a laminate comprising a combination of two or more thereof.

17. An image display device constituted using a laminate produced by the process according to claim 10.
